(19) United States
(12) Patent Application Publication
(10) Pub. No.: US 2009/0020513 A1
(43) Pub. Date: Jan. 22, 2009

(54) Laser Machining Apparatus and Method with a Vacuum Extracting System and at Least a First Containement Zone for Containing Deposition of Emitted Hazardous Material

(76) Inventors: John O'Halloran, Dublin (IE); John Tully, Cavan (IE); Pat Grimes, Dublin (IE)

Correspondence Address: SEYFARTH SHAW LLP, 131 S. DEARBORN ST., SUITE 2400, CHICAGO, IL, 60603-5803, US

(21) Appl. No.: 12/223,044

(22) PCT Filed: Feb. 1, 2007
(86) PCT No.: PCT/EP2007/000874

§ 371 Date: Jul. 21, 2008

(30) Foreign Application Priority Data
Feb. 2, 2006 (GB) 0602115.8

(51) Int. Cl. B23K 26/00; B23K 26/16

(52) U.S. Cl. 219/121.72; 219/121.67

(57) ABSTRACT

A laser machining apparatus arranged to machine material which emits a hazardous material during machining, includes a vacuum extraction system 24, 25 for extracting at least some of the emitted hazardous material from a machining region of the apparatus. At least a first containment zone 36 encompasses the machining region to contain deposition of any un-extracted emitted hazardous material to the machining region. A second containment zone 37 may surround the first containment zone and a pressure differential may be provided between the two containment zones to assist in containing deposition of hazardous materials to the first containment zone 36. A transfer chamber 40 may be provided for transferring machined material to a washing station to prevent release from the laser machining apparatus during the transfer of any emitted hazardous material deposited on the machined material.

### CROSS-REFERENCE TO RELATED APPLICATIONS

This application is derived from International Patent Application PCT/EP2007/000874 filed Feb. 1, 2007 and claims priority from UK Patent Application GB 0602115.8 filed Feb. 2, 2006.

### FIELD OF THE INVENTION

This invention relates to laser machining and in particular to extraction and containment of hazardous emissions during laser machining.

### BACKGROUND OF THE INVENTION

Traditionally, dicing of wafers and other semiconductors has been performed with mechanical dicing saws. Disadvantages with using mechanical saws are that mechanical stress caused by the saw on a wafer can result in reduced yield and a relatively large kerf is formed by the saw. Using lasers, it is possible to increase yield and also to reduce the width of the kerf or street between devices on the wafer, allowing an increase in a number of devices per wafer. An advantage from such a reduction in street width is particularly significant for devices in which the kerf is large in relation to a size of the devices.

Via production in wafers such as gallium arsenide has traditionally been performed chemically or using etch processes. Laser via machining offers a significant advantage in terms of versatility and reduced cost of ownership due to high throughput and flexibility.

However, the use of lasers in micro machining applications such as laser dicing and laser based via drilling of some materials may be hazardous because of emissions created during the machining process.

Whilst there have been proposals for laser dicing of materials, such as gallium arsenide, which may emit hazardous materials during laser machining, it is apparent that known tooling could not be used safely on a production basis as in known laser machining apparatus no attention has been directed to where generated particles may be deposited during the machining operation.

It is an object of the present invention at least to ameliorate the aforesaid deficiency in the prior art.

### BRIEF SUMMARY OF THE INVENTION

According to a first aspect of the invention, there is provided a laser machining apparatus arranged to machine a substrate which emits a hazardous material during laser machining, the apparatus comprising a vacuum extraction system, including a housing surrounding a machining region, for extracting at least some of the emitted hazardous material from a machining region of the apparatus and at least a first containment zone within the housing encompassing the machining region arranged substantially to contain deposition of any un-extracted emitted hazardous material to the first containment zone.

Preferably, the laser machining apparatus further comprises a second containment zone substantially surrounding the first containment zone arranged to contain deposition of any un-extracted hazardous material not deposited in the first containment zone.

Advantageously, an ambient gas pressure in the first containment zone in less than an ambient gas pressure in the second containment zone.

Conveniently, the laser machining apparatus further comprises a transfer chamber for transferring laser machined material from the machining region to a wash station arranged to wash any emitted hazardous material from the machined material, without release of the hazardous material to an environment of the laser machining apparatus during transfer.

Conveniently, the laser machining apparatus is arranged to machine a semiconductor wafer.

Advantageously, the laser machining apparatus is arranged at least one of to dice and to machine a via in the semiconductor wafer.

Conveniently, the laser machining apparatus is arranged to machine a III-V semiconductor.

Conveniently, the laser machining apparatus is arranged to machine an arsenide.

According to a second aspect of the invention, there is provided a method of laser machining a substrate which emits a hazardous material during laser machining, comprising the steps of: extracting at least some of the emitted hazardous material from a housing surrounding a machined region of the material; and providing at least a first containment zone encompassing the machined region within the housing and substantially containing deposition of any un-extracted emitted hazardous material in the first containment zone.

Preferably, the method further comprises providing a second containment zone substantially surrounding the first containment zone and containing in the second containment zone deposition of any un-extracted hazardous material not deposited in the first containment zone.

Advantageously, the method further comprises providing an ambient gas pressure differential between the first containment zone and the second containment zone to resist transfer of hazardous material from the first containment zone to the second containment zone.

Conveniently, the method further comprises providing a transfer chamber and transferring laser-machined material from the machining region to a wash station and washing any emitted hazardous material from the machined material, without release of the hazardous material to an environment of the laser machining apparatus during transfer.

Conveniently, the method is arranged to machine a semiconductor wafer.

Advantageously, the method is arranged at least one of to dice and to machine a via in the semiconductor wafer.

Conveniently, the method is arranged to machine a III-V semiconductor.

Conveniently, the method is arranged to machine an arsenide.

### BRIEF DESCRIPTION OF THE SEVERAL VIEWS OF THE DRAWING

The invention will now be described, by way of example, with reference to the accompanying drawings in which:

FIG. 1 is a perspective view of a portion of a laser machining apparatus according to the invention;

FIG. 2 is a cutaway drawing illustrating airflow through a machining portion of the laser machining apparatus of FIG. 1;

FIG. 3 is a schematic cross-section of a laser machining apparatus according to the invention;

FIG. 4 is a perspective drawing of a portion of the laser machining apparatus of FIG. 1 showing primary and secondary containment chambers; and

FIG. 5 is a perspective drawing of a portion of the laser machining apparatus of FIG. 1 showing a transport containment chamber for transporting a machined wafer from the machining portion of the apparatus to a wash station.

In the Figures, like reference numerals denote like parts.

### DETAILED DESCRIPTION OF THE INVENTION

A laser processing machine for processing semiconductor wafers may be used for dicing or for drilling via formations in semiconductor or other materials of the wafer or substrate. The machining process includes absorption of laser light by at least the material intended to be machined causing photoablation, photoionisation or other photodissociative phenomenon that result in the formation of gases and solid particle emissions, which may be damaging to the machine or dangerous for an operator, or which may react with materials in the local environment to form potentially dangerous compounds that may present a threat to the machine or operator.

One such process is laser machining of gallium arsenide with a q-switched pulsed laser. In this process gallium arsenide dissociates to form hazardous elemental arsenic. It is therefore necessary to prevent arsenic emission from the machining or cutting region of the laser machining apparatus.

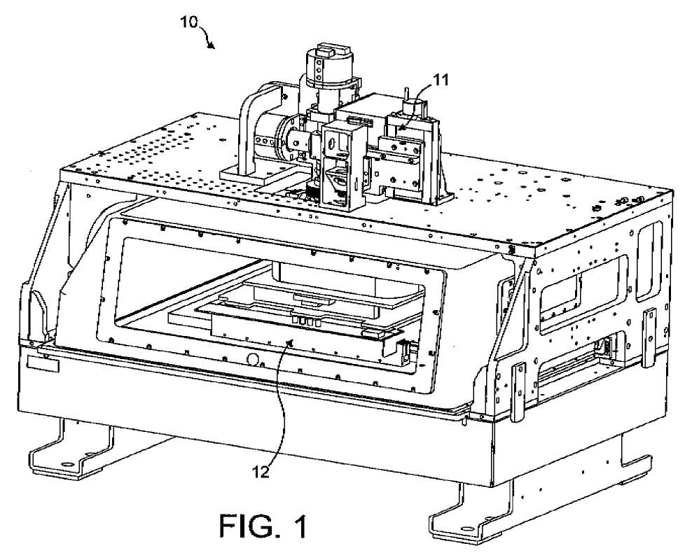

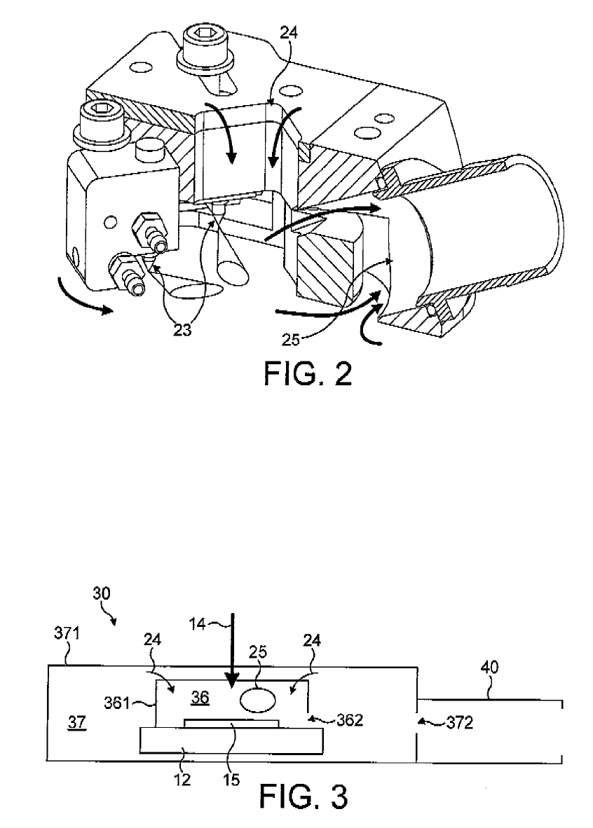

Referring to FIG. 1, a laser machining system 10 according to the invention comprises a laser with a beam delivery path (not shown) and a beam steering or positioning system 11. The beam positioning system may be a galvanometer or other scanning system which delivers a beam 14 (see FIG. 3) to a work surface 15. Alternatively a fixed beam may be used and the wafer 15 moved relative to the beam 14 allowing positioning of the beam at a specified location on the wafer. Typically, the beam positioning system includes an XY table 12 and may also include gas or liquid assist nozzles 23, as shown in FIG. 2, for delivering a gas or liquid to a machining region.

Whether using a steerable and positionable laser beam or a fixed laser beam 14, the laser machining process generally results in the emission of both particles and gases. Typically, if no precautions are taken, some of these particles and gases become airborne and can be carried to locations within the machine that are some distance from the machining region.

FIG. 2 illustrates a partial cross-section of a system designed for a galvo-based beam delivery system which provides a significant reduction in local emissions from the machining region during a laser machining process. The system includes an air flow input window 24 through which air enters from outside the machining region and an air flow output 25 through which air is drawn out of the machining region to remove particles, gases and debris from the machining region during the machining process for safe disposal or recycling. This extraction system provides a first mechanism for preventing emission of hazardous material to the environment and for preventing deposition of hazardous material in the general machine area outside the immediate machining region.

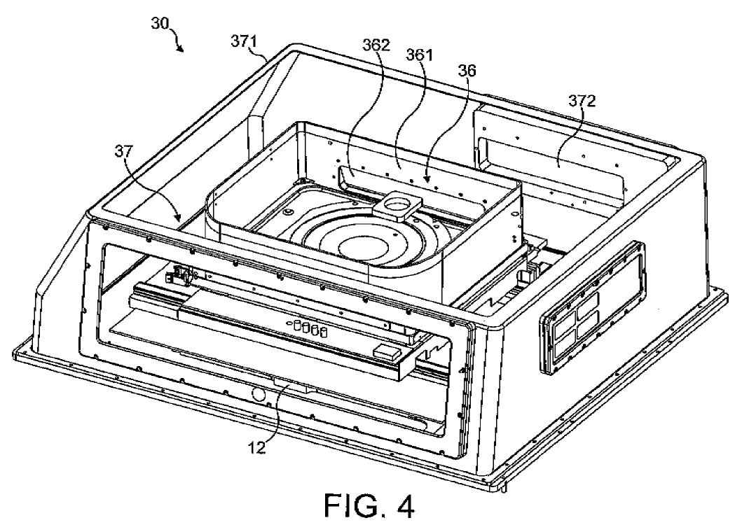

Referring to FIGS. 3 and 4, a second mechanism for prevention of unwanted material deposition involves use of a primary containment zone 36 and a secondary containment zone 37. The primary containment zone 36 is a volume immediately around the wafer 15. This area is separated from an area outside the primary containment zone by a vertical barrier 361 but is open at a top thereof. The barrier prevents significant deposition of material outside the primary containment zone 36 immediately around the wafer 15 and confines particle deposition to the primary containment zone 36 and the wafer 15. The barrier 361 is mounted on the XY table 12 onto which a wafer 15 is to be loaded so that the primary containment zone 36 moves on the XY table 12 with the wafer 15 during machining. A passage 362, substantially rectangular in cross-section, is provided through the vertical barrier 361 for loading a wafer 15 into the machining region within the primary containment zone 36 and unloading a machined wafer 15 from the machining region.

The secondary containment zone 37 surrounds the primary containment zone 36 defined by encompassing chamber walls 371, closed at a top thereof but transparent to the laser beam 14. A passage 372, substantially rectangular in cross-section, is provided through the chamber walls 371 so that the passage 362 in the primary containment zone wall 361 can be aligned with the passage 372 through the secondary containment zone walls 371 by suitable movement of the primary containment zone with the XY table.

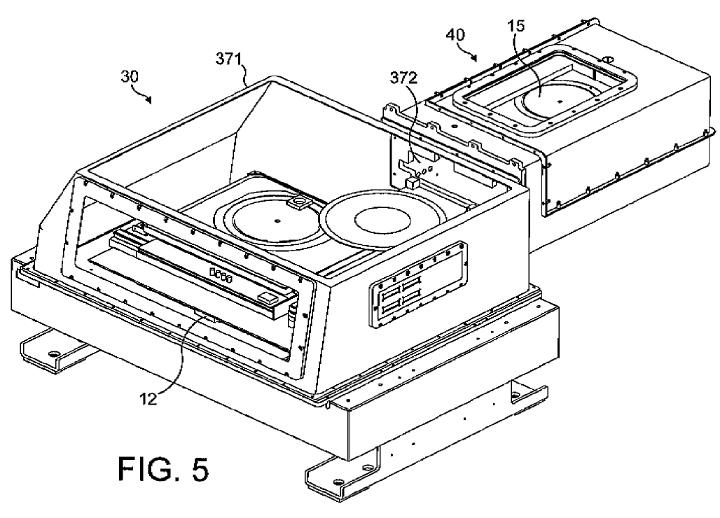

Referring to FIG. 3, and to FIG. 5 in which the walls 361 of the primary confinement zone 36 are omitted in the interests of clarity, a wafer handling system is provided to pick the wafer 15 from this machining region to transport the wafer through a confinement tunnel 40 aligned with the passage 372 in the chamber walls 371 and into a wash station. Sufficient hazardous material is removed from the wafer in the wash station for the washed wafer to be safe to handle.

Air pressure, or ambient gas pressure where the ambient gas is not air, is preferably held lower within the primary confinement zone 36 than in the secondary confinement zone 37 to seek to prevent hazardous particles being carried outside of the primary confinement zone 36. Any particles that do accidentally enter the secondary containment zone 37 are contained within the secondary confinement zone 37.

Thus the emission of hazardous material from the machining region is substantially prevented by extraction of a majority of particulate and gaseous emissions from the machining region, as shown in FIG. 2, and confinement of particularly particulate emissions to the wafer region in primary and secondary containment zones or chambers 36, 37 as shown in FIG. 4.

Most particulate and gas emission is removed from the machining zone by the extraction system illustrated in FIG. 2. The use of containment zones or chambers 36, 37 as described, effectively eliminates any deposition of hazardous material outside the secondary containment zone 37. Most deposition outside the immediate machining zone occurs in the primary containment zone 36. Wafers are loaded into this machining region by a handling system operating inside a transfer chamber 40. After machining, wafers are removed in a reverse manner and transferred to a wash system.

The invention potentially reduces machine downtime by reducing an amount of maintenance time required to keep the machine safe by preventing build-up of hazardous material in the general machine area.

There has been described a machine for laser processing a semiconductor wafer or other substrate where potentially hazardous materials are emitted during the machining process and where the machine is designed to extract or confine emissions so that they do not present a hazard to the well-being of personnel in the vicinity of the machine.

Thus the described laser machining system for machining hazardous materials comprises a localised vacuum exhaust system for the removal of hazardous particles and gases, a primary containment zone 36 designed to restrict hazardous material deposition to the area of the substrate being machined and a secondary containment zone 37 further to prevent hazardous material from reaching parts of the machine exposed to the atmosphere. A confinement passage 40 is provided to transport machined wafers 15 to a wash station before subsequent handling.

1. A laser machining apparatus arranged to machine a substrate which emits a hazardous material during laser machining, the apparatus comprising a vacuum extraction system including a housing surrounding a machining region for extracting at least some of the emitted hazardous material from a machining region of the apparatus and at least a first containment chamber within the housing encompassing the machining region arranged substantially to contain deposition of any un-extracted emitted hazardous material within the first containment chamber.

2. A laser machining apparatus as claimed in claim 1, comprising a second containment chamber defined by the housing substantially surrounding the first containment chamber arranged to contain deposition of any un-extracted hazardous material not deposited in the first containment chamber.

3. A laser machining apparatus as claimed in claim 2, wherein an ambient gas pressure in the first containment chamber in less than an ambient gas pressure in the second containment chamber.

4. A laser machining apparatus as claimed in claim 1, further comprising a transfer chamber for transferring laser machined material from the machining region to a wash station arranged to wash any emitted hazardous material from the machined material, without release of the hazardous material to an environment of the laser machining apparatus during transfer.

5. A laser machining apparatus as claimed in claim 1, arranged to machine a semiconductor wafer.

6. A laser machining apparatus as claimed in claim 5, arranged at least one of to dice and to machine a via in the semiconductor wafer.

7. A laser machining apparatus as claimed in claim 1, arranged to machine a III-V semiconductor.

8. A laser machining apparatus as claimed in claim 1, arranged to machine an arsenide.

9. A method of laser machining a substrate which emits a hazardous material during laser machining, comprising the steps of:
a. extracting at least some of the emitted hazardous material from a housing surrounding a machined region of the material; and
b. providing at least a first containment chamber encompassing the machined region within the housing and substantially containing deposition of any un-extracted emitted hazardous material in the first containment chamber.

10. A method as claimed in claim 9, comprising providing a second containment chamber defined by the housing substantially surrounding the first containment chamber and containing in the second containment chamber deposition of any un-extracted hazardous material not deposited in the first containment chamber.

11. A method as claimed in claim 10, comprising providing an ambient gas pressure differential between the first containment chamber and the second containment chamber to resist transfer of hazardous material from the first containment chamber to the second containment chamber.

12. A method as claimed in claim 9, further comprising providing a transfer chamber and transferring laser-machined material from the machining region to a wash station and washing any emitted hazardous material from the machined material, without release of the hazardous material to an environment of the laser machining apparatus during transfer.

13. A method as claimed in claim 9, arranged to machine a semiconductor wafer.

14. A method as claimed in claim 13, arranged at least one of to dice and to machine a via in the semiconductor wafer.

15. A method as claimed in claim 9, arranged to machine a III-V semiconductor.

16. A method as claimed in claim 9, arranged to machine an arsenide.
